(19) United States
(12) Patent Application Publication
(10) Pub. No.: US 2019/0218833 A1
(43) Pub. Date: Jul. 18, 2019

(54) LATCH MECHANISM FOR A VEHICLE

(71) Applicants: GM Global Technology Operations LLC, Detroit, MI (US); PyeongHwa Automotive Co. Ltd., Daegu (KR)

(72) Inventors: James N. Nelsen, Howell, MI (US); Hee Ra Park, Daegu (KR)

(73) Assignees: GM Global Technology Operations LLC, Detroit, MI (US); PyeongHwa Automotive Co. Ltd., Daegu (KR)

(21) Appl. No.: 15/871,568

(22) Filed: Jan. 15, 2018

(51) Int. Cl. E05B 83/24; E05B 85/24

(52) U.S. Cl. CPC E05B 83/24; E05Y 2900/536; E05B 85/243

(57) ABSTRACT

A latching mechanism to fasten a hood panel to a vehicle body includes a housing, a fork bolt releasably securing a striker and a component releasably engaging the fork bolt to adjust the fork bolt. A latch includes a body, a primary catch portion, a secondary catch portion and a pin extending from the body. A memory lever includes a body having a recess to receive the latch pin. A cancel lever includes a body having a first end adjustably connected to the memory lever and a second end extending proximate the second catch portion. The cancel lever cooperates with the secondary catch portion to engage the striker in the first unlatched position. The latch pin is received by the memory lever recess to releasably secure the latch in the second unlatched position and allow the striker to move from the latching mechanism to unfasten the hood panel.

The disclosure relates to a hood latch mechanism for a motor vehicle.

In motor vehicles, a hood or bonnet is a moveable, typically hinged, panel that selectively covers and permits access to a compartment defined by the vehicle body. In vehicles with a forward mounted engine, the hood permits access to the engine for maintenance. In vehicles with a mid-body or rearward mounted engine, the hood covers a storage compartment disposed in the forward portion of the vehicle.

Commonly, a vehicle hood is held down by a concealed latch. Such a latch is generally designed to protect the vehicle or the compartment contents from theft, damage, and sudden opening of the hood while the vehicle is in motion. A hood release system is common on the most vehicles, and typically includes an interior compartment hood latch handle, a hood release cable, and a hood latch assembly that cooperate to release and open the hood panel for access to the covered compartment.

### SUMMARY

A vehicle having a vehicle body defining a compartment includes a hood panel configured to cover the compartment and a striker. A latching mechanism releasably engages the striker and is adjustable between a latched position and at least one unlatched position. The latching mechanism includes a housing securable to a portion of the vehicle body. The housing includes a first side, an opposing second side and at least one cam surface formed in the housing.

A fork bolt is adjustably connected to the second side of the housing and is movable between a locked position wherein the fork bolt releasably secures the striker to fasten the hood panel to the vehicle body and an unlocked position wherein the striker is adjustable relative to the housing. A component is disposed proximate the housing to releasably engage the fork bolt. The component is actuated to adjust the fork bolt from the locked position to the unlocked position.

A latch is adjustably connected to the first side of the housing. The latch includes a body, a primary catch portion cooperating with the fork bolt to releasably secure the striker in a latched position, a secondary catch portion and a pin extending from the body. The latch is movable from the latched position to a first unlatched position wherein the secondary catch portion is positioned proximate a central region of the housing and a second unlatched position. An actuator cooperates with the component and includes a projection to engage the latch and adjust the latch from the first unlatched position to the second unlatched position.

A memory lever is adjustably connected to the housing proximate the latch and includes a body having a recess at least partially formed therein to receive the latch pin. A cancel lever includes a body having a first end adjustably connected to the memory lever and a second end extending proximate the second catch portion, wherein the cancel lever cooperates with the secondary catch portion to engage the striker in the first unlatched position. The latch pin is received by the memory lever recess to releasably secure the latch in the second unlatched position and allow the striker to move from the latching mechanism to unfasten the hood panel from the vehicle body.

The body of the cancel lever includes an upper surface received within and engaging the memory lever and a lower surface engaging the striker when the striker, latch and cancel lever are in the first unlatched position. The body of the memory lever includes a first end, an opposing second end and a central section extending between the first and second ends, wherein the central section includes a pivot pin to selectively adjust the memory lever relative to the housing of the latching mechanism.

The first end of the memory lever may be shaped to guide the latch pin to the recess in the body of the memory lever when the latch is adjusted from the first unlatched position to the second unlatched position. The first end of the cancel lever is adjustably connected to the second end of the body of the memory lever. The cancel lever causes the memory lever to adjust relative to the housing to release the latch pin to move the latch to translate from the second unlatched position to the latched position in response to the striker engaging the cancel lever as the striker is moved toward the fork bolt in the latching mechanism.

The fork bolt further includes a channel sized to receive and secure the striker in the latched position to fasten the hood panel to the vehicle body. The primary catch portion of the latch cooperates with the channel of the fork bolt in the latched position to fasten the hood panel to the vehicle body. A limiter and a slot formed in the latch body cooperates with the limiter to define a range of travel of the latch from the first unlatched position to the second unlatched position. The latching mechanism includes a first biasing member configured to apply a force to selectively preload the latch to facilitate closure of the compartment in the latched position and preload the secondary catch portion to limit the position of the hood panel in the first unlatched position.

In another embodiment, a latching mechanism to releasably engage a striker of a hood panel to a vehicle body includes a housing securable to the vehicle body having a first side, an opposing second side and at least one cam surface formed in the housing. A fork bolt is adjustably connected to the second side of the housing and movable between a locked position wherein the fork bolt releasably secures the striker to fasten the hood panel to the vehicle body and an unlocked position wherein the striker is adjustable relative to the housing. A component is disposed on the housing and configured to adjust the fork bolt from the locked position to the unlocked position.

A latch is adjustably connected to the first side of the housing. The latch includes a body, a primary catch portion cooperating with the fork bolt to releasably secure the striker in a latched position, a secondary catch portion and a pin extending from the body. The latch is movable from the latched position to a first unlatched position wherein the secondary catch portion is positioned proximate a central region of the housing and a second unlatched position. An actuator cooperates with the component including a projection to engage the latch and adjust the latch from the first unlatched position to the second unlatched position.

A memory lever is adjustably connected to the housing proximate the latch. The memory lever includes a first end, an opposing second end and a central section extending between the first and second ends having a recess at least partially formed therein to receive the latch pin to releasably secure the latch in the second unlatched position and allow the striker to move from the latching mechanism to unfasten the hood panel from the vehicle body.

The central section includes a pivot pin to selectively adjust the memory lever relative to the housing of the latching mechanism. A cancel lever includes a body having a first end adjustably connected to the memory lever, a second end extending proximate the second catch portion, an upper surface received within and engaging the memory lever and a lower surface engaging the striker when the striker, latch and cancel lever are in the first unlatched position. The cancel lever causes the memory lever to adjust relative to the housing to release the latch pin to move the latch to translate from the second unlatched position to the latched position in response to the striker engaging the cancel lever as the striker is moved toward the fork bolt in the latching mechanism.

In one non-limiting embodiment, the first end of the cancel lever is adjustably connected to the second end of the body of the memory lever. The first end of the memory lever may be shaped to guide the latch pin to the recess in the body of the memory lever when the latch is adjusted from the first unlatched position to the second unlatched position.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic top view of a vehicle showing a partially sectioned hood panel and an under-hood compartment covered thereby, according to the disclosure.

FIGS. 2A-2B are schematic front and rear views of a latching mechanism with a striker shown in a latched position;

FIGS. 3A-3B are schematic front and rear views of the latching mechanism in an actuated position with the striker shown in the latched position;

FIGS. 4A-4B are schematic front and rear views of the latching mechanism shown in a first unlatched position;

FIG. 5 is a perspective view showing the latching mechanism and striker in the first unlatched position as illustrated in FIGS. 4A-4B;

FIGS. 6A-6B are schematic front and rear views of the latching mechanism shown in a second unlatched position;

FIG. 7 is a schematic front view of the latching mechanism and striker shown in the second unlatched position with adjustment of a cancel lever relative to a housing of the latching mechanism;

FIG. 8 is a schematic front view of the latching mechanism with the striker engaging the cancel lever as the latching mechanism and striker are returned to the latched position; and

FIGS. 9A-9B are schematic front and rear views of the latching mechanism shown in the latched position wherein the latching mechanism releasably engages the striker to selective fasten the hood panel to the vehicle body according to the disclosure.

### DETAILED DESCRIPTION

Reference will now be made in detail to several embodiments of the disclosure that are illustrated in accompanying drawings. Whenever possible, the same or similar reference numerals are used in the drawings and the description to refer to the same or like parts or steps. The drawings are in simplified form and are not to precise scale. For purposes of convenience and clarity, directional terms such as top, bottom, left, right, up, over, above, below, beneath, rear, and front, may be used with respect to the drawings. These and similar directional terms are not to be construed to limit the scope of the disclosure.

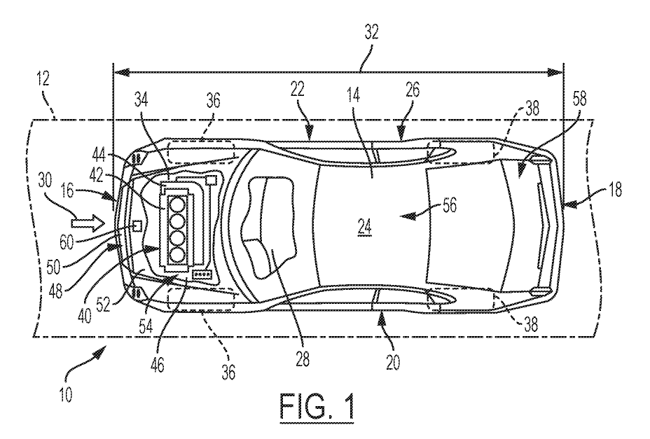

Referring to the drawings, wherein like reference numbers correspond to like or similar components throughout the several Figures, an example vehicle 10 is shown schematically in FIG. 1. The vehicle 10 may include, but not be limited to, a commercial vehicle, industrial vehicle, passenger vehicle, aircraft, watercraft, train or any mobile platform. It is also contemplated that the vehicle 10 may be any mobile platform, such as an airplane, all-terrain vehicle (ATV), boat, personal movement apparatus, robot and the like to accomplish the purposes of this disclosure.

The vehicle 10 in FIG. 1 is positioned relative to a road surface 12. The vehicle 10 includes a first end or front end 16, an opposing second end or rear end 18, a first lateral portion or left side 20 generally extending between the first and second ends 16, 18, and an opposing second lateral portion or right side 22. The vehicle body 14 further includes a top body portion 24, which may include at least a vehicle roof portion, and an opposing lower body portion or underbody 26. A passenger compartment 28 is defined in the vehicle body 14.

As understood by those skilled in the art, the first or front end 16 may face oncoming ambient airflow 30 when the vehicle 10 is in motion relative to the road surface 12. Each of the left side, right side, top, and underbody body sections, 20, 22, 24, and 26, respectively, spans a distance 32 between the front and rear ends 16, 18 of the body 14.

The vehicle 10 includes one or more wheels 36, 38 arranged between the first and second vehicle body ends 16, 18, proximate the left and right sides 20, 22. The one or more wheels includes a first set of wheels 36 disposed proximate the first or front end 16 of the vehicle 10 and a second set of one or more wheels 38 disposed proximate the second or rear end 18 of the vehicle 10. As shown in FIG. 1, the first set of one or more wheels 36 includes a pair of front wheels that are rotatably connected to the vehicle 10 and rotate about an axis while the second set of one or more wheels 38 includes a pair of rear wheels that are rotatably connected to the vehicle 10 and rotate about an axis.

The vehicle 10 also includes a powertrain 40 that may include an internal combustion engine 42 for generating engine torque. The powertrain 40 may also include a transmission 44 operatively connecting the engine 42 to at least some of the road wheels 36, 38 for transmitting engine torque thereto and thereby put the vehicle 10 in motion. The powertrain 40 of the vehicle 10, if the vehicle is a hybrid type, may include one or more motor-generators, none of which are shown, but the existence of which can be appreciated by those skilled in the art. Efficiency of a vehicle powertrain 40 is generally influenced by its design, as well as by the various loads the powertrain 40 sees during its operation.

The vehicle body 14 defines a compartment 46 for housing the powertrain 40. As described above, the compartment 46 shown in FIG. 1 houses the powertrain 40. However, it is understood that the compartment 46 may be configured as a storage compartment or other vehicle space if the powertrain 40 of the vehicle 10 is positioned in a central or rear portion of the vehicle 10.

As shown, the vehicle body 14 also includes a vehicle fascia 48 arranged at the front end 16. The fascia 48 defines at least one opening 50 receiving at least some of the oncoming ambient airflow 30, which may be used for cooling the powertrain 40. Generally, the at least one opening 50 that is provided in the front end 16 of the vehicle 10, such as the grille openings 50, as well as various protruding features on the surface of the vehicle body 14, tend to impact the vehicle's 10 aerodynamic signature. Although one grille opening 50 is depicted and described, nothing precludes the vehicle 10 from having a greater number of grille openings for admitting the ambient airflow 30 into the compartment 46 from the ambient atmosphere.

The vehicle 10 also includes a hood panel or bonnet 52 adjustably mounted to the vehicle body 14 and movable between at least one open position where the hood panel 52 is unfastened from the vehicle body 14 to provide access to the compartment 46 and a closed position wherein the hood panel 52 extends at least partially above and across to cover the compartment 46 to restrict access to the compartment 46. The hood panel 52 and compartment 46 cooperate to define an under-hood compartment 54 for housing the powertrain 40. The hood panel 52 may be pivotally mounted to one or more load-bearing body frame members of the body 14 of the vehicle 10 to provide access to and securely close the top portion of the compartment 46. The vehicle 10 may also include a vehicle roof, generally represented by numeral 56, and a trunk lid 58. Corresponding to the specifically shown front-engine configuration of the vehicle 10, the hood panel 52 is depicted as arranged generally proximate the front end 16, while the trunk lid 58 is arranged generally proximate the rear end 18 of the vehicle body 14 of the vehicle 10.

The under-hood compartment 54 of the vehicle 10 may accept a number of alternative distinct powertrains 40. A specific powertrain 40 may be selected based on the intended use of the vehicle 10 or the general preference of the vehicle's user. Accordingly, during the initial design of the vehicle 10, the under-hood compartment 54 typically accommodates each of the alternative powertrains 40. Hence, although the physical size of the alternative powertrains 40, as well as the power output of the respective engines, may be vastly different, the overall size and layout of the particular under-hood compartment 54 remains relatively unchanged.

The vehicle 10 is equipped with a latch and lock system that employs a concealed hood latch or latching mechanism 60 movable between a latched position to secure the hood panel 52 in a closed position relative to the vehicle body 14, as shown in FIG. 1 and at least one unlatched position. It is contemplated that the latching mechanism 60 is mounted to the front or forward portion of the vehicle 10 with a hood panel 52 that opens from the forward portion of the vehicle 10. The latching mechanism 60 cooperates with the hood panel 52 to secure the hood panel 52 proximate the compartment 46 in the vehicle body 14. Further, it is contemplated that the latching mechanism 60 of the present disclosure may be configured for use without an external handle or member cooperating with the latching mechanism 60 to releasably secure the hood panel 52 to the latching mechanism 60 and thereby, the hood panel 52 to the vehicle 10.

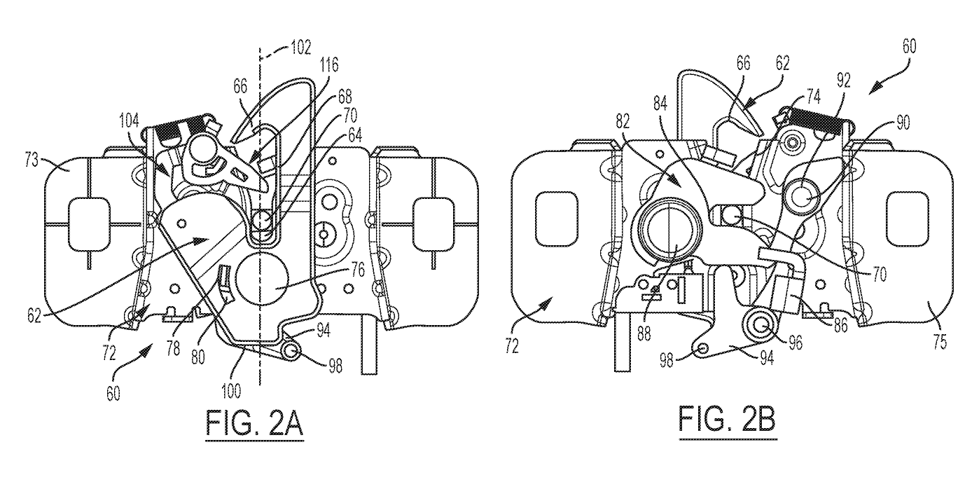

Referring additionally now to FIGS. 2A-2B, the latching mechanism 60 is illustrated in latched or first position. The first position of the latching mechanism 60 may also be referred to as an unactuated position. The latching mechanism 60 may selectively fasten and releasably secure the hood panel 52 as shown in FIG. 1 proximate to the vehicle body 14 such that the hood panel 52 maintains closure of the compartment 46. For purposes of clarity, FIG. 2A illustrates the latching mechanism 60 from a forward portion of the vehicle 10 proximate the front end 16 of the vehicle 10, while FIG. 2B illustrates the mechanism from a rearward portion of the vehicle 10, such as from the position of the passenger compartment 28.

While the latching mechanism 60 is illustrated in one non-limiting configuration in FIGS. 2A-2B, it is understood that the latching mechanism 60 may be installed in a variety of positions and arrangements depending upon the configuration of the vehicle 10. For example, the front or forward view may be reversed with the rear or rearward views such that the latch 62 may be mounted to either the front or the rear of the tie bar structure. Further, the latching mechanism 60 may be configured for use in right hand drive and left-hand drive vehicle configurations in order to dictate the cable going to the driver's side of the vehicle. Additionally, the latching mechanism 60 may use different part configurations than as illustrated. For example, in the case of a latching mechanism 60 disposed on the rearward side of the tie bar structure on a left-hand drive vehicle, a part of the latching mechanism 60 for use with a right-hand drive vehicle may be used to allow a cable exit towards the driver's side of the vehicle 10.

The latching mechanism 60 includes a latch 62 having a body adjustably connected to and movable relative to a housing 72 having a primary catch portion 64 facilitating or maintaining closure of the under-hood compartment 54 via a striker 70 cooperating with the hood panel 52 such that the panel 52 is being positioned adjacent or against the vehicle body 14. The latch 62 also includes a secondary catch portion 66 that receives the striker 70, and thereby, may limit, such as constrain and/or maintain, the position of the hood panel 52 as shown in FIG. 1 within a predetermined distance from the vehicle body 14. Such limiting of the position of the hood panel 52 by the secondary catch portion 66 within the predetermined distance of the vehicle body 14 creates an opening between the vehicle body 14 and the hood panel 52.

As shown in the Figures, the latch 62 is a unitary actuator such that the primary catch portion 64 is in communication with the secondary catch portion 66 by a body 68. As illustrated, primary catch portion 64 may be disposed on a lower end of the body 68 relative to the latch housing 72 while the secondary catch portion 66 may be disposed on an upper end of the body 68. However, it may be appreciated that the primary catch portion 64 and secondary catch portion 66 of the latch 62 may be distinct components that work in unison or individually from each other.

The body 68 may guide the latch 62, such as by establishing or defining a rotational path or motion thereof, via contact with a striker 70. The striker 70 of the latching mechanism 60 cooperates with the latch 62. The position of the hood panel 52 as shown in FIG. 1 is specifically limited to within the predetermined distance of travel of the striker 70 between the primary catch portion 64 in the latched position and the secondary catch portion 66 in the at least one unlatched position.

As shown, the body 68 is arranged at least between the primary catch portion 64 and the secondary catch portion 66. The body 68 may define a curved path for contact with the striker 70. The latch 62 is mounted to housing 72, while the housing 72 is in turn fixed to a portion of the vehicle body 14. The latch 62 may be mounted to the housing 72 via a fastener, such as a rivet or the like.

The housing 72 includes a first side 73, an opposing second side 75 and at least one cam surface 74 formed therein. The first side 73 of the housing 72 may receive the latch 62 pivotally connected thereto. The at least one cam surface 74 may be formed in a central region of the housing 72 defined between the first side 73 and the opposing second side 75 of the housing 72 and is sized to receive and guide the striker 70 therethrough. The primary catch portion 64, secondary catch portion 66 and body 68 on the latch 62 are positioned adjacent the at least one cam surface 74 in the central region of the housing 72.

The latching mechanism 60 may include a first biasing member or element, generally referenced by numeral 76, such as a clock spring or the like, operating bi-directionally and applying a force to selectively preload the primary catch portion 64 of the latch 62 to selectively rotate in opposing directions. The biasing member 76 may be configured such that, depending on the position of the latch 62, the force of the biasing member 76 may be applied in one direction, or another, opposite direction. For example, as shown in FIGS. 1 and 2A-2B, the force of the biasing member 76 is applied in a first direction, such as clockwise direction, to maintain the primary catch portion 64 in a latched or unactuated state or position to facilitate closure of the under-hood compartment 54 via the hood panel 52.

The latching mechanism 60 may also include a limiter 78 that may travel in a slot defining a range of motion for the latch 62. The limiter 78 may cooperate with and extend from the housing 72 or may be a distinct component of the latching mechanism 60. The slot 80 may be formed in a portion of the latching mechanism 60 in a variety of geometries and positions. In one non-limiting example, slot 80 may be arcuate in shape and define a predetermined angle of rotation for the latch 62 relative to a pivot center. The slot 80 may be sized to allow the limiter 78 to travel therein and thereby, limit the range of motion of the limiter 78 within the geometry defining the slot 80.

Referring now to FIG. 2B, the latching mechanism 60 may also include a fork bolt 82 cooperating with an actuator 94 and having a channel 84 sized to receive and secure the striker 70 in the latched position to fasten the hood panel 52 to the vehicle body 14. The fork bolt 82 may be positioned on the housing 72 such that the fork bolt 82 and channel 84 of the fork bolt 82 are disposed proximate the at least one cam surface 74. In one non-limiting embodiment, the fork bolt 82 is pivotally connected to the second side 75 of the housing 72 on the opposing surface from the latch 62 and is movable between a locked position wherein the channel 84 in the fork bolt 82 secures the striker 70 to fasten the hood panel 52 to the vehicle body 14 in the latched position and an unlocked position allowing the fork bolt 82 to be removed from the channel 84.

The latching mechanism 60 may additionally include a component 86 pivotally connected to the second side 75 of the housing 72 and that releasably engages the fork bolt 82 to move the fork bolt 82 from a locked position to an unlocked position such that the panel 52 may be manually or automatically opened. The component 86 may also be referred to as a detent or a pawl. The component 86 may be connected to and cooperate with a hood latch release mechanism, such as a cable, a handle, a motorized actuator, a lever with a catch, a solenoid and/or other user interface actuated by the operator of the vehicle 10. The hood latch release mechanism (not shown) may be positioned inside the passenger compartment 28 of the vehicle 10, such as underneath the steering column or adjacent the driver seat frame.

In a mechanical system architecture, pulling on the hood latch release mechanism such as a release lever that cooperates with the component 86 will apply a tensile force to a hood latch release cable (not shown), such as a Bowden-type cable. The component 86 activates and thereby disengages the latching mechanism 60 to allow the hood panel 52 to be moved to an open position. Other mounting and latching architectures, including mechanical, electrical, and electro-mechanical configurations, are envisioned as being within the scope of this disclosure. For instance, the release cable may be representative of an electrical wire harness or fiber optic cable in applications where the hood latch mechanism 60 is embodied as a power hood latch.

The release of the fork bolt 82 frees the hood panel 52 to separate from the vehicle body 14 at least a predetermined distance and thereby establish an opening between the vehicle body 14 and the hood panel 52. The component 86 may be actuated remotely from the vehicle's 10 passenger compartment 28 or by a remote activation component (not shown) to operatively release the fork bolt 82 to allow the striker 70 to be moved from the channel 84 of the fork bolt 82.

The latching mechanism 60 may additionally include a second biasing member or element (not shown), which may be a clock spring or the like, operatively connected to the fork bolt 82 to allow the fork bolt 82 to selectively rotate relative to the housing 72. The second biasing member may apply a preload force directed to shift or move the fork bolt 82 from a locked position to an unlocked position where the fork bolt 82 releases the striker 70 and permits the hood panel 52 to move away from the vehicle body 14 in response to a first actuation of the detent or component 86. The fork bolt 82 along with the second biasing member may be operatively connected to the housing 72 via a suitable fastener 88, such as a rivet or the like.

A third biasing member or element (not shown) may be provided to cooperate with the component 86. The third biasing member may be a spring or the like that may apply a force to at least a portion of the component 86 to release the fork bolt 82 from the latched position to the disengaged position in response to actuation of the component 86. The third biasing member may be operatively connected to the housing 72 via a suitable fastener 92.

FIGS. 2A-2B illustrate the latching mechanism 60 in a first position or latched position. An actuator 94 cooperates with and extends from a portion of the component 86 to engage the latch 62. The actuator 94 may be operatively connected to a portion of the component 86 by a fourth biasing member or element, generally referenced by numeral 96, which may include a clock spring or the like. The fourth biasing member 96 may apply a preload force directed to shift the actuator 94 to a position where the actuator 94 engages a portion of the latch 62.

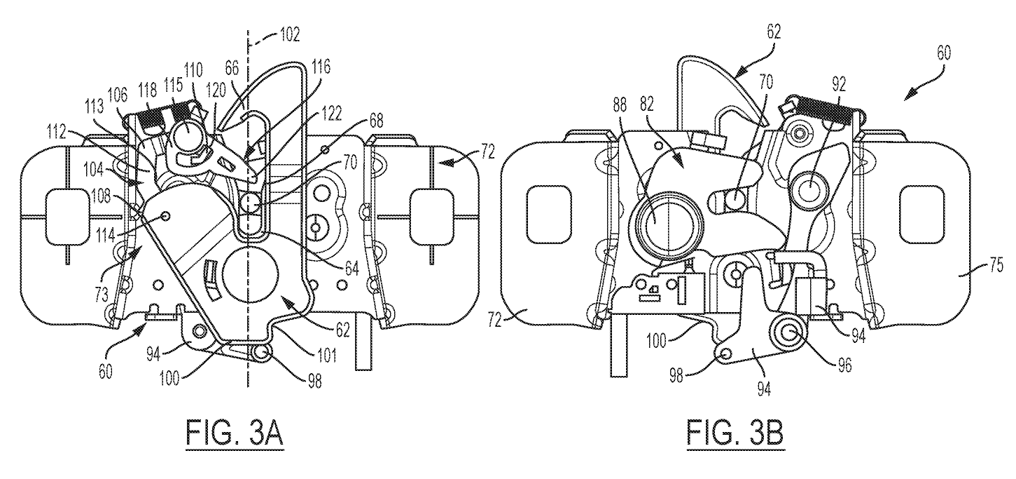

The actuator 94 may be positioned proximate the latch 62. As shown in the Figures, the actuator 94 may be disposed on one side of the housing 72 while the latch 62 is disposed on an opposing side of the housing 72. The actuator 94 includes a projection 98 extending from a surface of the actuator 94. The projection 98 may engage at least one surface of the latch 62. The projection 98 may be of a unitary structure with the actuator 94 and may be disposed adjacent a lower surface 100 of the latch 62 in FIGS. 3A-3B.

Referring now to FIGS. 3A-3B, the latching mechanism 60 and striker 70 are illustrated wherein the latch mechanism 60 is actuated and the striker 70 is shown prior to movement from the latched position to at least one unlatched position. The component 86 may be actuated to release the fork bolt 82 from engagement with the component 86. As illustrated in FIGS. 3A-3B, the component may selectively rotate about the third biasing member between at least an engaged position and a disengaged position.

The second biasing member may apply a force to shift or selectively rotate the fork bolt 82 in a counterclockwise manner from the locked position to an unlocked position where the fork bolt 82 releases the striker 70 when the component 86 releases the fork bolt 82. In response to movement of the component 86, the actuator 94 may adjust or selectively rotate about the fourth biasing member 96 such that the projection 98 on actuator 94 is disposed proximate the lower surface 100 of the latch 62. It is contemplated that the projection 98 may engage the lower surface 100 of the latch 62.

As shown in FIGS. 3A-3B, the striker 70 may be positioned at least partially within the portion of the fork bolt 82 and adjacent the primary catch portion 64 of the latch 62 when the fork bolt 82 is actuated. Actuation of the fork bolt 82 by the component 86 allows the striker 70 to be moved from the fork bolt 82 and adjusted from the latched position to the first unlatched position.

The latching mechanism 60 includes a memory lever 104 adjustably connected to a portion of the housing 72 proximate the latch 62. Memory lever 104 includes a body 106 having a first end 108, an opposing second end 110 and a central region or section 112 extending between the first and second ends 108, 110. The first end 108 of the memory lever 104 may be disposed adjacent to a portion of the latch 62.

In one non-limiting embodiment, the latch 62 includes a pin or elongate projection 114 extending from a surface of the latch 62. The first end 108 of the memory lever 104 may be shaped to engage the pin 114 and guide the pin 114 along the first end 108 to a recess 113 at least partially formed in the central section 112 of the body 106 of the memory lever 104 as the latch 62 and memory lever 104 is adjusted from the first unlatched position to a second unlatched position relative to each other and the housing 72 in the operation of the latching mechanism 60. The memory lever 104 may be pivotally mounted to a portion of the housing 72 by a pivot pin 115 or the like to allow the memory lever 104 to selectively adjust and/or rotate relative to the housing 72 of the latching mechanism 60.

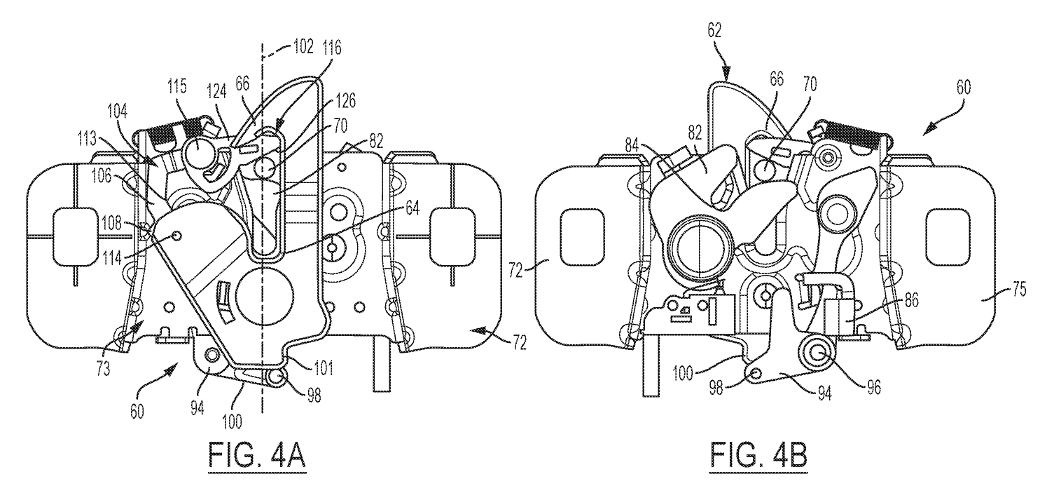

A cancel lever 116 includes a body 118 having a first end portion 120 adjustably connected to the second end 110 of the memory lever 104 and an opposing second end portion 122. As best shown in FIG. 4A, the body 118 of the cancel lever 116 further includes an upper surface 124 and an opposing lower surface 126. As shown in FIG. 3A, the second end portion 122 of cancel lever 116 extends from the memory lever 104 generally above a central region of the latching mechanism 60 as identified by line 102 and proximate the secondary catch portion 66 in the housing 72 and the latch 62. The second end portion 122 of the cancel lever 116 may be disposed between the primary catch portion 64 and secondary catch portion 66 of the latch 62.

Referring now to FIGS. 4A-4B, the latching mechanism 60 is shown with the striker 70 positioned in a second position or a first unlatched position. It is contemplated that the at least one unlatched position may further include a first unlatched position and a second unlatched position as described herein. The striker 70 is released from the fork bolt 82 and proximate the primary catch portion 64 and travels at least partially through the housing 72 proximate the at least one cam surface 74 between the latched position shown in FIGS. 2A-2B to the first unlatched position. As striker 70 travels toward the secondary catch portion 66, the striker 70 engages the lower portion or surface 126 of the cancel lever 116 positioned between the primary catch portion 64 and secondary catch portion 66.

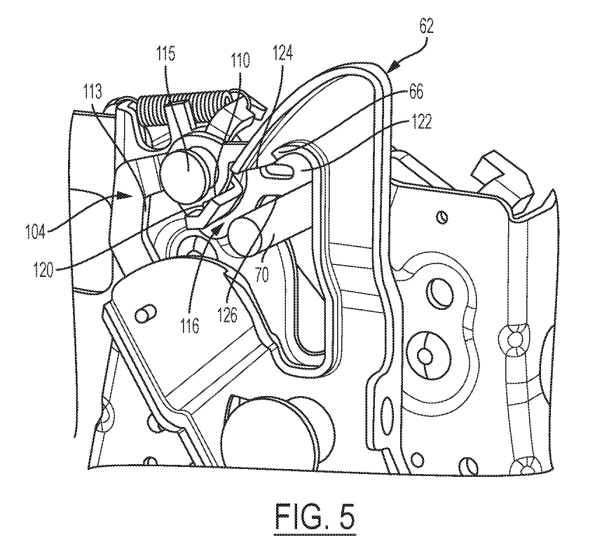

As is shown in FIGS. 4A and 5, the cancel lever 116 adjusts about the second end section 110 of the memory lever 104 in response to the engagement by the striker 70 and is moved to a position between the striker 70 and the secondary catch portion 66. In one non-limiting embodiment, the second end portion 122 and upper surface 124 of the body 118 of the cancel lever 116 are shaped such that the upper surface 124 of the body 118 is received within and engages the secondary catch portion 66. In this arrangement, the secondary catch portion 66 cooperates with the cancel lever 116 to stop travel of the striker 70 relative to the housing 72 and position the striker 70 in the second unlatched position. However, it is understood that in an alternative embodiment, the cancel lever 116 may be mounted to the memory lever 104 such that the cancel lever 116 may stop the travel of the striker 70 and position the striker 70 in the first unlatched position without the use of or support by the secondary catch portion 66 of the latch 62.

In the first unlatched position, the latch 62 is positioned such that the secondary catch portion 66 extends generally above the central region 102 of the latching mechanism 60. The secondary catch portion 66 releasably engages and receives the cancel lever 116 as the striker 70 moves to the full travel of the first unlatched position. It is also contemplated that, when the cancel lever 116 engages the secondary catch portion 66, the secondary catch portion 66 may provide physical feedback to the component 86 and related components to indicate completion of the movement.

It is further contemplated that, in response to positioning of the striker 70 adjacent the cancel lever 116 and proximate the secondary catch portion 66, the component 86 is repositioned to the latched position as shown in FIGS. 2A-2B. As the component 86 is repositioned, the actuator 94 translates about the member 96 such that the projection 98 of actuator 94 is placed in and engages a portion or channel 101 in the lower surface 100 of the latch 62.

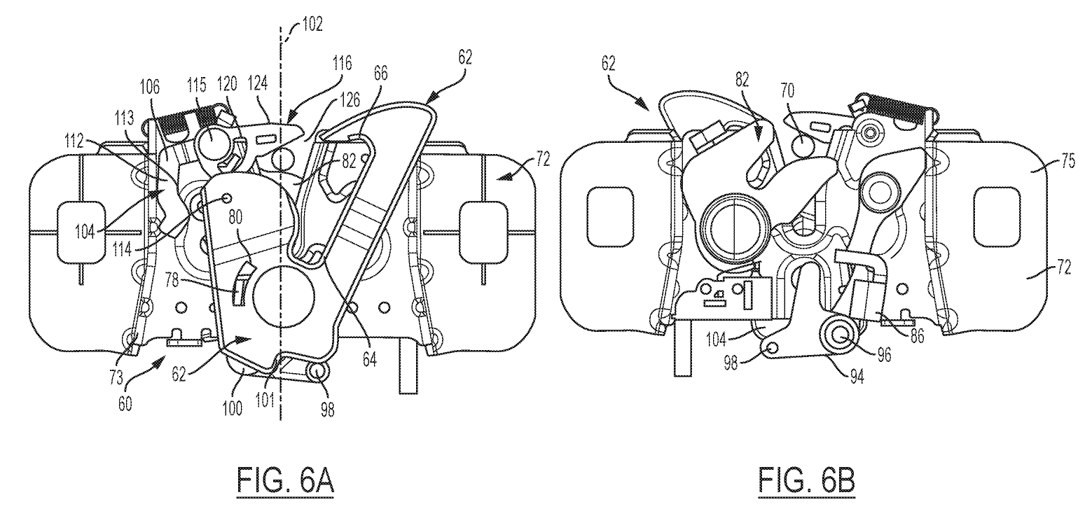

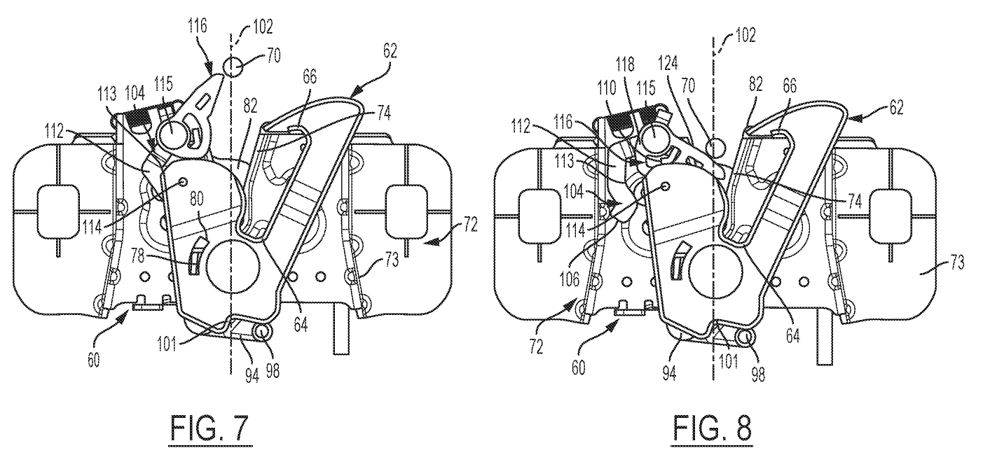

Referring now to FIGS. 6A-6B and 7, adjustment of the latch 62 of the latching mechanism 60 from the second position or first unlatched position to a third position or a second unlatched position to release the striker 70 from the latch 62 to allow adjustment of the hood panel relative to the vehicle body is described in greater detail. The second unlatched position may also be referred to as the fully unlatched or open position. In the transition from the first unlatched position to the second unlatched position, the actuator 94 cooperating with component 86 is adjusted such that projection 98 engages the portion or channel 101 of the lower surface 100 of the latch 62 when the component 86 is actuated, thereby translating the latch 62 from the first unlatched position to the second unlatched position.

In response to actuation of the component 86, the latch 62 is selectively rotated or translated relative to the housing 72 such that the secondary catch portion 66 is translated away from a position adjacent the central region 102 of the latching mechanism 60. Further, the secondary catch portion 66 disengages the cancel lever 116 as the latch 62 is translated away from the central region 102 of the latching mechanism 60. Additionally, the limiter 78 cooperating with and extending from the housing 72 into the slot 80 of the latch 62 may travel in the slot 80 of the latch 62. The slot 80 defines the predetermined angle of rotation for the latch 62 relative to a pivot center and thereby, limits the range of motion of the limiter 78 within the geometry defining the slot 80.

As the latch 62 is adjusted from the first unlatched position to the second unlatched position, the latch 62 is translated away from the central region 102 of the latching mechanism 60. The pin 114 on the latch 62 adjusts from a position generally proximate the first end 108 of the body 106 of the memory lever 104 toward the recess 113 in the central section 112 of the memory lever 104.

It is contemplated that the positioning the pin 114 in the recess 113 of the memory lever 104 will releasably secure the latch 62 in the second unlatched position, thereby allowing the striker 70 to exit the latching mechanism 60. Further, the memory lever 104 will position and retain the latch 62 in the second unlatched position until the striker 70 is reinserted into the latching mechanism 60 as will be described in greater detail below.

Referring now to FIG. 7, in the second unlatched position, the striker 70 disengages from the cancel lever 116. The cancel lever 116 is translated relative to the memory lever 104 away from the central region 102 of the latching mechanism 60 in response to the upward movement of the striker 70 relative to the housing 72 such that the striker 70 may be removed from the latching mechanism 60 to allow the hood panel 52 to be released and adjusted relative to the body vehicle 14 illustrated in FIG. 1. The cancel lever 116 may cooperate with a biasing member or may be translated back to a position proximate the central region 102 of the latching mechanism 60 after the striker 70 is removed from the latching mechanism 60.

FIG. 8 illustrates the striker 70 and latching mechanism 60 as the hood panel 52 illustrated in FIG. 1 cooperating with the striker 70 is moved toward a position proximate the vehicle body 14 to secure the hood panel 52 to the vehicle 10. Striker 70 engages the upper surface 124 of the body 118 of the cancel lever 116 as the hood panel 52 is moved toward the vehicle 10. As the striker 70 moves toward the primary catch portion 64 of the latch 62 and the fork bolt 82, the cancel lever 116 is adjusted toward the latch 62 and central region 102 of the latching mechanism 60 or clockwise relative to the housing 72 and latch 62 of the latching mechanism 60. Further, the movement of the cancel lever 116 is translated from the cancel lever 116 to the memory lever 104.

In one non-limiting embodiment, adjustment of the cancel lever 116 in response to engagement by the striker 70 causes the second end 110 of the memory lever 104 to rotate about the pivot 115 relative to the housing 72 of the latching mechanism 60 toward the central region 102 of the latching mechanism 60. As the memory lever 104 adjusts about the pivot 115, the recess 113 in the central region 112 of the body 106 of the memory lever 104 disengages and releases the pin 114 extending from the latch 62 such that the latch 62 translates from the second unlatched position to the latched position.

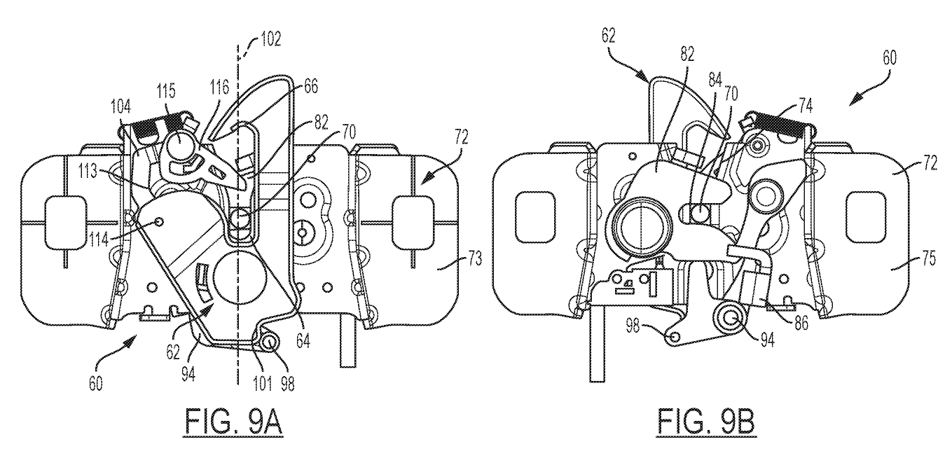

As shown in FIGS. 9A-9B, the latch 62, in response to action from the first biasing member 76, is adjusted from third position or second unlatched position to the first position or latched position. The latch 62 will be positioned on the latching mechanism 60 such that the primary catch portion 64 and secondary catch portion 66 are aligned with the central region 102 of the latching mechanism 60 to receive and secure the striker 70 to the fork bolt 82 of the latching mechanism 60.

The latching mechanism 60 is shown in the latched position in FIGS. 9A-9B. The striker 70 is positioned in the latching mechanism 60 to relatch the striker 70 in the channel 84 of the fork bolt 82. The fork bolt 82 is positioned on the housing 72 such that the channel 84 of the fork bolt 82 is aligned with the at least one cam surface 74. When the hood 52 is positioned adjacent the vehicle body 14, the striker 70 travels through the at least one cam surface 74 into and engaging the channel 84 of the fork bolt 82 to place the fork bolt 82 in the latched position.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

1. A vehicle comprising:
a vehicle body defining a compartment;
a hood panel adjustably mounted to the vehicle body and at least partially covering the compartment, the hood panel including a striker; and
a latching mechanism releasably engaging the striker, the latching mechanism including:
a housing securable to the vehicle body having a first side, an opposing second side and at least one cam surface formed in the housing,
a fork bolt adjustably connected to the second side of the housing and movable between a locked position wherein the fork bolt releasably secures the striker to fasten the hood panel to the vehicle body and an unlocked position wherein the striker is adjustable relative to the housing,
a component disposed on the housing and configured to adjust the fork bolt from the locked position to the unlocked position,
a latch adjustably connected to the first side of the housing, the latch having a body, a primary catch portion cooperating with the fork bolt to releasably secure the striker in a latched position, a secondary catch portion and a pin extending from the body, wherein the latch is movable from the latched position to a first unlatched position wherein the secondary catch portion is positioned proximate a central region of the housing and a second unlatched position,
an actuator cooperating with the component including a projection to engage the latch and adjust the latch from the first unlatched position to the second unlatched position,
a memory lever adjustably connected to the housing proximate the latch including a body having a recess at least partially formed therein to receive the latch pin, and
a cancel lever including a body having a first end adjustably connected to the memory lever and a second end extending proximate the second catch portion, wherein the cancel lever cooperates with the secondary catch portion to engage the striker in the first unlatched position,
wherein the latch pin is received by the memory lever recess to releasably secure the latch in the second unlatched position and allow the striker to move from the latching mechanism to unfasten the hood panel from the vehicle body.

2. The vehicle of claim 1 wherein the body of the cancel lever further comprises an upper surface received within and engaging the memory lever and a lower surface engaging the striker when the striker, latch and cancel lever are in the first unlatched position.

3. The vehicle of claim 1 wherein the body of the memory lever further comprises a first end, an opposing second end and a central section extending between the first and second ends, wherein the central section includes a pivot pin to selectively adjust the memory lever relative to the housing of the latching mechanism.

4. The vehicle of claim 3 wherein the first end of the memory lever is shaped to guide the latch pin to the recess in the body of the memory lever when the latch is adjusted from the first unlatched position to the second unlatched position.

5. The vehicle of claim 3 wherein the first end of the cancel lever is adjustably connected to the second end of the body of the memory lever.

6. The vehicle of claim 5 wherein the cancel lever causes the memory lever to adjust relative to the housing to release the latch pin to move the latch to translate from the second unlatched position to the latched position in response to the striker engaging the cancel lever as the striker is moved toward the fork bolt in the latching mechanism.

7. The vehicle of claim 1 wherein the fork bolt further comprises a channel sized to receive and secure the striker in the latched position to fasten the hood panel to the vehicle body.

8. The vehicle of claim 7 wherein the primary catch portion of the latch cooperates with the channel of the fork bolt in the latched position to fasten the hood panel to the vehicle body.

9. The vehicle of claim 1 wherein the latching mechanism further comprises a limiter and a slot formed in the latch body, wherein the slot cooperates with the limiter to define a range of travel of the latch from the first unlatched position to the second unlatched position.

10. The vehicle of claim 1 wherein the latching mechanism further comprises a first biasing member configured to apply a force to selectively preload the latch to facilitate closure of the compartment in the latched position and preload the secondary catch portion to limit the position of the hood panel in the first unlatched position.

11. A latching mechanism to releasably engage a striker of a hood panel to a vehicle body comprising:
a housing securable to the vehicle body having a first side, an opposing second side and at least one cam surface formed in the housing;
a fork bolt adjustably connected to the second side of the housing and movable between a locked position wherein the fork bolt releasably secures the striker to fasten the hood panel to the vehicle body and an unlocked position wherein the striker is adjustable relative to the housing;
a component disposed on the housing and configured to adjust the fork bolt from the locked position to the unlocked position;
a latch adjustably connected to the first side of the housing, the latch having a body, a primary catch portion cooperating with the fork bolt to releasably secure the striker in a latched position, a secondary catch portion and a pin extending from the body, wherein the latch is movable from the latched position to a first unlatched position wherein the secondary catch portion is positioned proximate a central region of the housing and a second unlatched position;
an actuator cooperating with the component including a projection to engage the latch and adjust the latch from the first unlatched position to the second unlatched position;
a memory lever adjustably connected to the housing proximate the latch including a body having a recess at least partially formed therein to receive the latch pin; and
a cancel lever including a body having a first end adjustably connected to the memory lever and a second end extending proximate the second catch portion, wherein the cancel lever cooperates with the secondary catch portion to engage the striker in the first unlatched position,
wherein the latch pin is received by the memory lever recess to releasably secure the latch in the second unlatched position and allow the striker to move from the latching mechanism to unfasten the hood panel from the vehicle body.

12. The latching mechanism of claim 11 wherein the body of the cancel lever further comprises an upper surface received within and engaging the memory lever and a lower surface engaging the striker when the striker, latch and cancel lever are in the first unlatched position.

13. The latching mechanism of claim 11 wherein the body of the memory lever further comprises a first end, an opposing second end and a central section extending between the first and second ends, wherein the central section includes a pivot pin to selectively adjust the memory lever relative to the housing of the latching mechanism.

14. The latching mechanism of claim 13 wherein the first end of the cancel lever is adjustably connected to the second end of the body of the memory lever.

15. The latching mechanism of claim 14 wherein the cancel lever causes the memory lever to adjust relative to the housing to release the latch pin to move the latch to translate from the second unlatched position to the latched position in response to the striker engaging the cancel lever as the striker is moved toward the fork bolt in the latching mechanism.

16. The latching mechanism of claim 11 wherein the fork bolt further comprises a channel sized to receive and secure the striker in the latched position to fasten the hood panel to the vehicle body.

17. The latching mechanism of claim 16 wherein the primary catch portion of the latch cooperates with the channel of the fork bolt in the latched position to fasten the hood panel to the vehicle body.

18. A latching mechanism to releasably engage a striker of a hood panel to a vehicle body comprising:
a housing securable to the vehicle body having a first side, an opposing second side and at least one cam surface formed in the housing;
a fork bolt adjustably connected to the second side of the housing and movable between a locked position wherein the fork bolt releasably secures the striker to fasten the hood panel to the vehicle body and an unlocked position wherein the striker is adjustable relative to the housing;
a component disposed on the housing and configured to adjust the fork bolt from the locked position to the unlocked position;
a latch adjustably connected to the first side of the housing, the latch having a body, a primary catch portion cooperating with the fork bolt to releasably secure the striker in a latched position, a secondary catch portion and a pin extending from the body, wherein the latch is movable from the latched position to a first unlatched position wherein the secondary catch portion is positioned proximate a central region of the housing and a second unlatched position;
an actuator cooperating with the component including a projection to engage the latch and adjust the latch from the first unlatched position to the second unlatched position;
a memory lever adjustably connected to the housing proximate the latch, the memory lever including a first end, an opposing second end and a central section extending between the first and second ends having a recess at least partially formed therein to receive the latch pin to releasably secure the latch in the second unlatched position and allow the striker to move from the latching mechanism to unfasten the hood panel from the vehicle body, wherein the central section includes a pivot pin to selectively adjust the memory lever relative to the housing of the latching mechanism; and
a cancel lever including a body having a first end adjustably connected to the memory lever, a second end extending proximate the second catch portion, an upper surface received within and engaging the memory lever and a lower surface engaging the striker when the striker, latch and cancel lever are in the first unlatched position, wherein the cancel lever causes the memory lever to adjust relative to the housing to release the latch pin to move the latch to translate from the second unlatched position to the latched position in response to the striker engaging the cancel lever as the striker is moved toward the fork bolt in the latching mechanism.

19. The latching mechanism of claim 18 wherein the first end of the cancel lever is adjustably connected to the second end of the body of the memory lever.

20. The latching mechanism of claim 18 wherein the first end of the memory lever is shaped to guide the latch pin to the recess in the body of the memory lever when the latch is adjusted from the first unlatched position to the second unlatched position.
